(19) United States
(12) Patent Application Publication
(10) Pub. No.: US 2014/0221475 A1
(43) Pub. Date: Aug. 7, 2014

(54) PLATINUM(IV) COMPLEXES AND PHARMACEUTICAL COMPOSITION CONTAINING THE SAME

(71) Applicants: Hisae Arai, Kashiwa-shi (JP); Hisao Kondo, Kashiwa-shi (JP); Norio Masuda, Kashiwa-shi (JP)

(72) Inventors: Hisae Arai, Kashiwa-shi (JP); Hisao Kondo, Kashiwa-shi (JP); Norio Masuda, Kashiwa-shi (JP)

(73) Assignee: UNITECH CO., LTD., Chiba (JP)

(21) Appl. No.: 14/232,719

(22) PCT Filed: Jul. 9, 2012
(86) PCT No.: PCT/JP2012/067471

§ 371 Date: Apr. 8, 2014

(30) Foreign Application Priority Data
Jul. 15, 2011 (JP) 2011-156527

(51) Int. Cl. C07F 15/00

(52) U.S. Cl. CPC C07F 15/0093
USPC 514/492; 556/137

(57) ABSTRACT

New platinum(IV) complexes which has a strong antitumor activity and has a feature that a side effect is relatively reduced is provided. The new complex is platinum(IV) complexes with cis,cis-spiro[4,4]nonane-1,6-diamine ligand and is platinum(IV) complexes with optically active cis,cis-spiro[4,4]nonane-1,6-diamine ligand. Especially, the new complex is dichloromalonato((1S,5S,6S)-spiro[4.4]nonane-1,6-diamine)platinum(IV).

### TECHNICAL FIELD

This invention relates to new platinum(IV) complexes and a pharmaceutical composition as an active ingredient, and particularly to a therapeutic agent for malignant tumors.

### BACKGROUND ART

Recently, the malignant tumors come to hold the top of the cause of death. On the other hand, the various kinds of antitumor materials are developed. Among these, as to the platinum complex, the antitumor action is acknowledged conventionally, and such as cisplatin [I], carboplatin [II] and oxaliplatin [III] are developed, and used for medical treatment (for example, refer to Non-patent document No. 1-Non-patent document No. 3). Besides, as the platinum complex which is effective to antitumor action, this applicant has Japanese patent registration No. 4664424 (Patent document No. 1) in relation to a new spiro[4,4]nonane-1,6-diamineplatinum(II) complex and the pharmaceutical composition which has an active ingredient thereof.

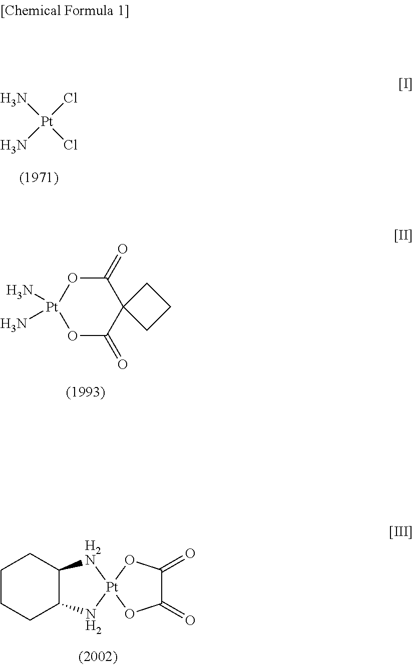

### PRIOR ART DOCUMENT

### Patent Document

Patent document No. 1: Japanese patent registration No. 4664424
Patent document No. 2: U.S. Pat. No. 4,140,707 (Feb. 20, 1979)

### Non-Patent Document

Non-patent document No. 1: Nature, 1969, 222 385-386
Non-patent document No. 2: Cancer Treat Reviews, 1985, 12 21-33
Non-patent document No. 3: Cancer Letters, 1985, 27 135-143

### SUMMARY OF THE INVENTION

### Problem to be Solved by the Invention

However, there were problems that the cisplatin has many side-effects such as nephrotoxicity, hematotoxicity, toxicity for digestive organs, and neurotoxicity. In this situation, the carboplatin was developed as the one which reduced the nephrotoxicity of the cisplatin and increased the water solubility, but the carboplatin was expensive. In addition, the antitumor action was not necessarily satisfactory. Although these have the antitumor activity, it is necessary to administer the predetermined required quantity corresponding to it to work the predefined antitumor activity. Therefore, there is a defect that these have the side-effects.

The object of this invention is to provide the new complex. The new complex is platinum(IV) complexes with cis,cis-spiro[4,4]nonane-1,6-diamine ligand and platinum(IV) complexes with optically active cis,cis-spiro[4,4]nonane-1,6-diamine ligand, and the complex has the stronger antitumor activity and has the effect with smaller doses, and thereby the side-effect is reduced relatively.

The object of this invention is to provide the new platinum(IV) complexes which has following feature. The new complex is dichloromalonato((1S,5S,6S)-spiro[4.4]nonane-1,6-diamine)platinum(IV) (G) which is described by the following formula (G) especially, and has the strong antitumor activity for malignant tumors, especially human lung cancer cell, human gastric cancer cell, human prostate cancer cell, human malignant melanoma cell, human bladder cancer cell, human lymphoma cell, human leukemia cell. And the side-effect is reduced relatively.

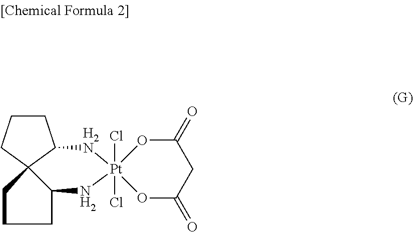

### Means for Solving the Problems

For achieving these objects, the therapeutic agent for the malignant tumor of this invention is platinum(IV) complexes with cis,cis-spiro[4,4]nonane-1,6-diamine (A) ligand which is represented by following general formula.

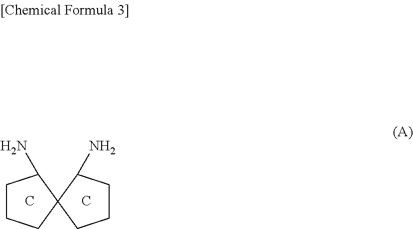

This invention is platinum(IV) complexes with optically active (1S,5S,6S)-spiro[4,4]nonane-1,6-diamine (B) ligand and platinum(IV) complexes with optically active (1R,5R,6R)-spiro[4,4]nonane-1,6-diamine (C) ligand.

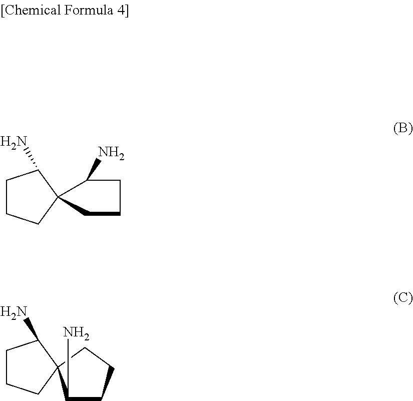

This invention is platinum(IV) complexes (D) with cis,cis-spiro[4,4]nonane-1,6-diamine (A) ligand which is represented by following general formula.

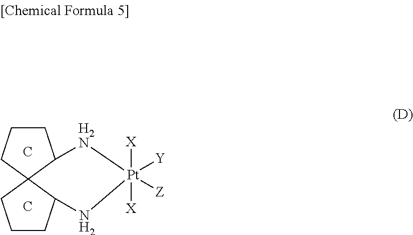

In the formula, X and Y, Z are same or different, and X and Y, Z represent halogen atoms or monovalent anionic group including acetate group respectively, or Y and Z cooperatively represent the divalent residue which is represented by the formula (b).

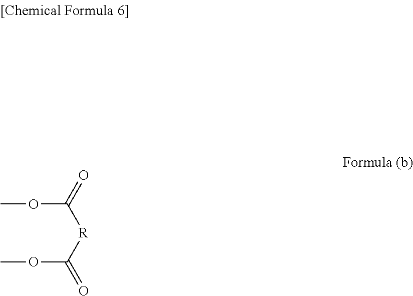

In the formula, R represents the single bond or represents the straight-chain or branched-chain divalent hydrocarbon residue whose number of carbon atom is 1-6. The hydrocarbon residue may have the unsaturated bond, and the hydrocarbon residue may form the spiro structure.

This invention is platinum(IV) complexes (E) with optically active (1S,5S,6S)-spiro[4,4]nonane-1,6-diamine (B) ligand and platinum(IV) complexes (F) with optically active (1R,5R,6R)-spiro[4,4]nonane-1,6-diamine (C) ligand which are represented by following stereostructual formula.

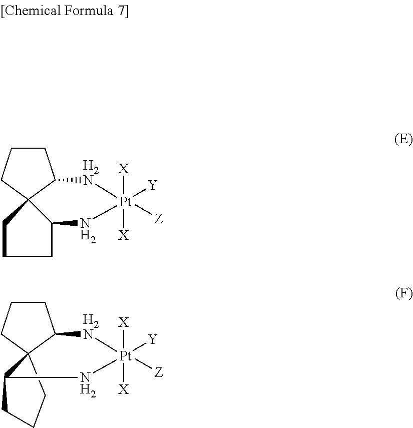

In the formula, X and Y, Z are same or different, and X and Y, Z represent halogen atoms or monovalent anionic group including acetate group respectively, or Y and Z cooperatively represent the divalent residue which is represented by the formula (b).

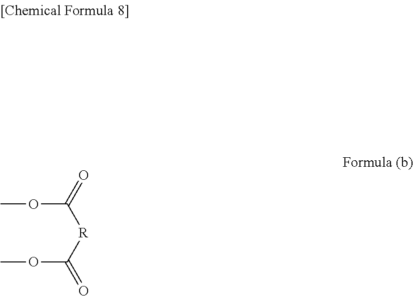

In the formula, R represents the single bond or represents the straight-chain or branched-chain divalent hydrocarbon residue whose number of carbon atom is 1-6. The hydrocarbon residue may have the unsaturated bond, and the hydrocarbon residue may form the spiro structure.

This invention is dichloromalonato((1S,5S,6S)-spiro[4.4]nonane-1,6-diamine)platinum(IV) which is represented by the following formula (G).

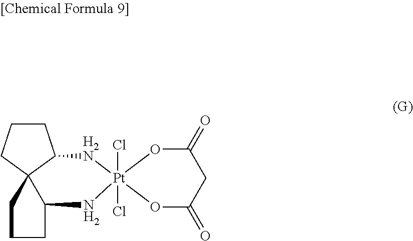

This invention is a pharmaceutical composition including the platinum(IV) complexes of each above-described formula as an active ingredient.

This invention is a therapeutic agent for malignant tumors including the platinum(IV) complexes of each above-described formula as an active ingredient.

For achieving these objects, the inventors of this application found that the new spiro[4,4]nonane-1,6-diamineplatinum(II) complex which is represented by following general formula (a) and the pharmaceutical composition having this complex as the active ingredient are effective for the therapeutic agent for malignant tumors, and filed the patent application (Japanese patent application NO. 2008-225698).

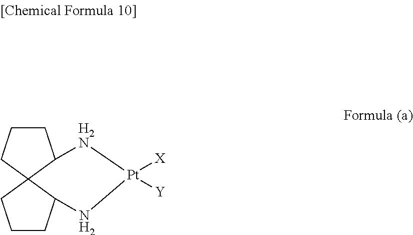

In the formula, X and Y are same or different, and X and Y represent halogen atoms respectively, or X and Y cooperatively represent the divalent residue which is represented by the formula (b).

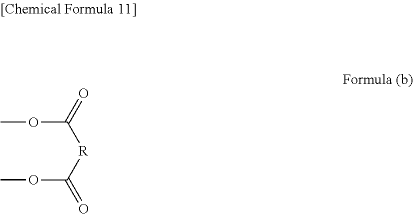

In the formula, R represents the single bond or represents the straight-chain or branched-chain divalent hydrocarbon residue whose number of carbon atom is 1-6. The hydrocarbon residue may have the unsaturated bond, and the hydrocarbon residue may form the spiro structure.

Besides, it was cleared that platinum(II) complex (H) with (cis,cis-spiro[4,4]nonane-1,6-diamine)oxalato which is especially represented in the following formula (c) had the strong antitumor activity for the malignant tumors, especially the nonsolid tumor such as the human lymphoma cell, and had the feature that the side-effect is reduced relatively.

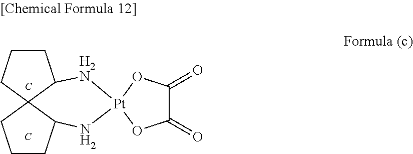

The cis,cis-spiro[4,4]nonane-1,6-diamine exists as optically active racemate which has two steric structures, that is, (S,S,S) form and (R,R,R) form. The inventors of this application further progressed the invention, investigated these optically active diamine platinum complexes, filed the patent application (Japanese patent application No. 2009-155399), and had the patent registration (Patent document No. 1).

### Effect of the Invention

The new platinum(IV) complexes of this invention has the strong antitumor activity for various malignant tumors such as human lung cancer cell, human gastric cancer cell, human prostate cancer cell, human malignant melanoma cell, human bladder cancer cell, human lymphoma cell, human leukemia cell, and has the effect compared with the conventional therapeutic agent for the malignant tumor of the platinum complex with smaller doses. Therefore, the side-effect is reduced relatively.

### MODE FOR CARRYING OUT THE INVENTION

Hereinafter, the platinum(IV) complexes of this invention and the therapeutic agent for the malignant tumor containing it are explained in connection with the embodiments.

The cis,cis-spiro[4,4]nonane-1,6-diamine (A), the optically active (1S,5S,6S)-spiro[4,4]nonane-1,6-diamine (B), the optically active (1R,5R,6R)-spiro[4,4]nonane-1,6-diamine (C), and the synthesis of the platinum(II) complexes (H), (I), (J) from these have been already explained by the patent of the inventors of this application (Japanese patent application No. 2009-155399, International patent application PCT/JP2009/004077).

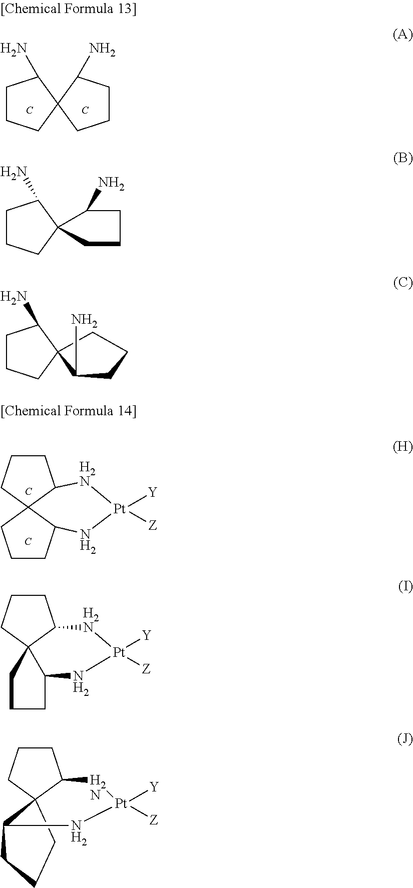

The platinum(IV) complexes (D), (E), (F) of this invention are obtained easily by applying the heretofore known method, for example the methods which are described in J. Inorg. Biochem., 1996, 61, 291-310, J. Med. Chem., 1997, 40, 112-116 (reaction formula (i) and reaction formula (ii)).

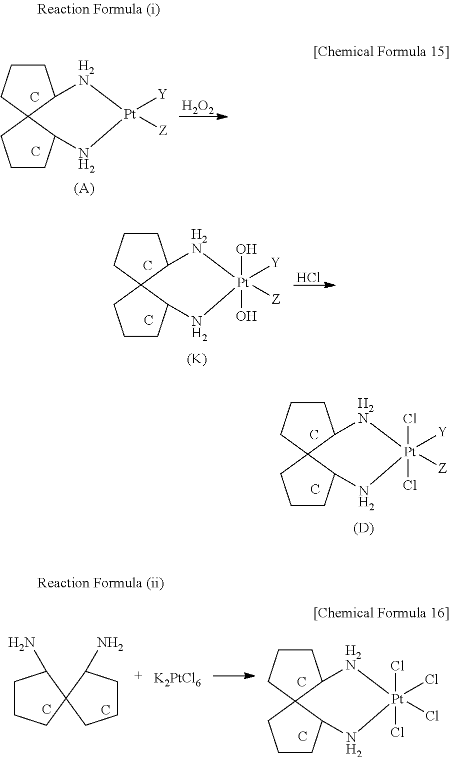

Although there is the case that this complex contains water as an aqueous complex, the aqueous body is also contained in this invention.

It became clear that the complex of this invention blocked the proliferation with low concentration for human lung cancer cell, human gastric cancer cell, human prostate cancer cell, human malignant melanoma cell, human bladder cancer cell, human lymphoma cell, human leukemia cell, and that the complex of this invention showed the strong antitumor action. The complex of this invention is effective for the therapeutic agent for malignant tumors.

When the therapeutic agent which contains the efficacious dose of the platinum complex of this invention is administered in the clinical practice, it is performed by the oral administration or the parenteral administration. The formulation includes such as tablet, sugar-coated tablet, ball, capsule, powdered medicine, lozenge, liquid medicine, suppository, injectable solution, and these are manufactured by blending the excipients which are allowable as medicine. As the excipient, the following one can be exemplified. These are such as lactose, sucrose, glucose, sorbitol, mannitol, potato starch, amylopectin, other various starches, cellulose derivative (for example, carboxymethyl cellulose, hydroxyethyl cellulose), gelatin, calcium stearate, magnesium stearate, polyvinyl alcohol, polyethylene glycol wax, gum arabic, talc, titanium dioxide, vegetable oil such as olive oil, peanut oil or sesame oil, paraffin oil, neutral fat base, ethanol, propylene glycol, saline, sterilized water, glycerin, coloring agent, seasoned formulation, thickener, stabilizer, isotonic agent, buffering agent, and other excipients which are allowable as medicine.

The therapeutic agent of this invention can contain the platinum complexes of this invention of 0.001-85% by weight, and preferably, can contain the platinum complexes of 0.005-60% by weight.

The dose of the therapeutic agent of this invention is mainly influenced by the symptom. However, it is 0.005-200 mg per an adult weight per a day, and preferably, it is 0.01-50 mg.

The embodiments are enumerated as follows, and this invention is explained more concretely.

### Embodiment 1

Malonato((S,S,S)-spiro[4,4]nonane-1,6-diamine)platinum(II) of 0.49 g was put in the round bottom flask of 50 ml, and the distilled water of 22 ml and 30% hydrogen peroxide water of 5.4 ml were added, and then these were heated and stirred for 2 hours at 70 degrees centigrade. These were cooled till room temperature and further stirred for 24 hours. The filtration was implemented by celite and the filtered one was washed by water. After concentrating the filtered solution, acetone (200 ml) was added and left. Appeared solid was filtrated, washed by acetone and dried. The appeared solid was washed by water, after that by ethanol, further by diethyl ether, and dried. Dihydroxy complexes of malonato((S,S,S)-spiro[4,4]nonane-1,6-diamine)platinum(IV) of 0.48 g was obtained. The yield was 93.6%.

This Pt(IV) compound of 0.52 g was put in the round bottom flask of 200 ml, 0.02N hydrochloric acid of 98 ml was added to this, and obtained one was stirred for 4 days in the dark place. The filtration was implemented by celite, the filtered one was washed by water and by methanol, and solvent was distilled away. The residue was solved in methanol, filtered by celite again, and the methanol was distilled away and dried. Dichloro complexes (G) of the malonato((S,S,S)-spiro[4,4]nonane-1,6-diamine)platinum(IV) of 0.33 g was obtained. The yield was 59.4%.

| Elementary analysis | C | H | N | Cl | Pt as C₁₂H₂₀N₂O₄Cl₂Pt |
|---|---|---|---|---|---|
| Calculated value (%) | 27.60 | 3.86 | 5.36 | 13.58 | 37.4 |
| Measured value (%) | 26.95 | 3.92 | 5.16 | 13.11 | 36.7 |

IR(KBr): 3177 (N—H), 1645 (C═O), 1371 (C—O) cm⁻¹

MS(ESI): m/z 521

From the above results, it was identified that this compound had the chemical structure which was represented by a (compound 1).

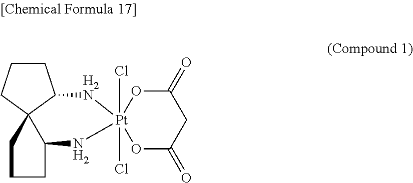

### Embodiment 2

Malonato((R,R,R)-spiro[4,4]nonane-1,6-diamine)platinum(II) of 1.23 g was put in the round bottom flask of 50 ml, and the distilled water of 18 ml and 30% hydrogen peroxide water of 4.4 ml were added, and then these were heated and stirred for 2 hours at 70 degrees centigrade. These were cooled till room temperature and further stirred for 24 hours. The filtration was implemented by celite and the filtered one was washed by water. After concentrating the filtered solution, acetone (200 ml) was added and left. Appeared solid was filtrated, washed by acetone and dried. Dihydroxy complexes of malonato((R,R,R)-spiro[4,4]nonane-1,6-diamine)platinum(IV) of 1.19 g was obtained. The yield was 90.0%.

This Pt(IV) compound of 1.04 g was put in the round bottom flask of 300 ml, 0.02N hydrochloric acid of 204 ml was added to this, and obtained one was stirred for 4 days in the dark place. The filtration was implemented by celite, the filtered one was washed by water and by methanol, and solvent was distilled away. The residue was solved in methanol, filtered by celite again, and the methanol was distilled away and dried. An optical isomer of Dichloro complexes (G) of the malonato((R,R,R)-spiro[4,4]nonane-1,6-diamine)platinum(IV) of 0.84 g was obtained. The yield was 74.8%.

The result of IR measurement corresponded to the platinum(IV) complex of the embodiment 1, and it was identified as a (compound 2).

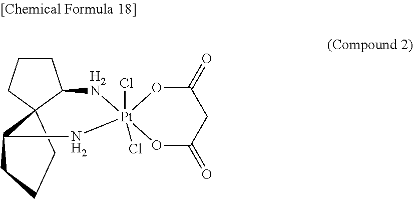

### Embodiment 3

Oxalato((S,S,S)-spiro[4.4]nonane-1,6-diamine)platinum(II) of 1.07 g was put in the round bottom flask of 50 ml, and the distilled water of 50 ml and 30% hydrogen peroxide water of 12.4 ml were added, and then these were heated and stirred for 2 hours at 70 degrees centigrade. These were cooled till room temperature and further stirred for 2 days. The filtration was implemented by celite and the filtered one was washed by water. After concentrating the filtered solution, acetone (200 ml) was added and left. Appeared solid was filtrated, washed by acetone and dried. The appeared solid was washed by water, after that ethanol, further diethyl ether, and dried. Dihydroxy complexes of an oxalato((S,S,S)-spiro[4.4]nonane-1,6-diamine)platinum(IV) of 1.15 g was obtained. The yield was 99.6%.

This Pt(IV) compound of 0.88 g was put in the round bottom flask of 300 ml, the distilled water of 165 ml and 1.2N hydrochloric acid of 2.85 ml were added to this, and obtained one was stirred for 3 days in the dark place. The filtration was implemented by celite, the filtered one was washed by water and by methanol, and solvent was distilled away.

The residue was solved in methanol, filtered by celite again, and the methanol was distilled away and dried. Dichloro complexes of the oxalato((S,S,S)-spiro[4.4]nonane-1,6-diamine)platinum(IV) of 0.79 g was obtained. The yield was 83.1%.

| Elementary analysis | C | H | N | Cl | Pt as C₁₁H₁₈N₂O₄Cl₂Pt |
|---|---|---|---|---|---|
| Calculated value (%) | 25.99 | 3.57 | 5.51 | 13.95 | 38.4 |
| Measured value (%) | 25.55 | 3.65 | 5.26 | 13.35 | 37.9 |

IR(KBr): 3175 (N—H), 1715 (C═O), 1357 (C—O) cm⁻¹

MS(ESI): m/z 507

From the above results, it was identified that this compound had the chemical structure which was represented by a (compound 3).

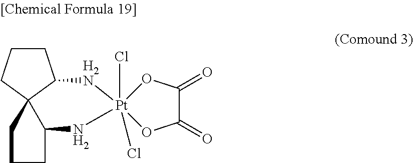

### Embodiment 4

Oxalato((R,R,R)-spiro[4.4]nonane-1,6-diamine)platinum(II) of 1.06 g was put in the round bottom flask of 50 ml, and the distilled water of 49 ml and 30% hydrogen peroxide water of 12.8 ml were added, and then these were heated and stirred for 2 hours at 70 degrees centigrade. These were cooled till room temperature and further stirred for 3 days. The filtration was implemented by celite and the filtered one was washed by water. After concentrating the filtered solution, acetone (250 ml) was added and left. Appeared solid was filtrated, washed by acetone and dried. Dihydroxy complexes of an oxalato((R,R,R)-spiro[4.4]nonane-1,6-diamine)platinum(IV) of 1.11 g was obtained. The yield was 97.3%.

This Pt(IV) compound of 0.92 g was put in the round bottom flask of 300 ml, the distilled water of 190 ml and 1.2N hydrochloric acid of 3.3 ml were added to this, and obtained one was stirred for 3 days in the dark place. The filtration was implemented by celite, the filtered one was washed by water and by methanol, and solvent was distilled away.

The residue was solved in methanol, filtered by celite again, and the methanol was distilled away and dried. Dichloro complexes of the oxalato((R,R,R)-spiro[4.4]nonane-1,6-diamine)platinum(IV) of 0.92 g was obtained. The yield was 92.4%.

The result of IR measurement corresponded to the platinum(IV) complex of the embodiment 3, and it was identified as a (compound 4).

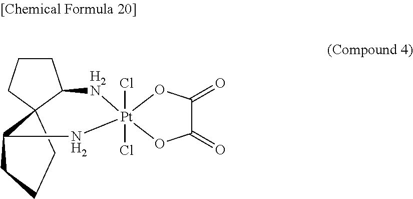

### Embodiment 5

Potassium hexachloroplatinate(IV) of 0.49 g, sodium chloride of 0.24 g and the distilled water of 60 ml were put in the round bottom flask of 100 ml and solved. The water solution of 10 ml of the (S,S,S)-spiro[4,4]nonane-1,6-diamine of 0.16 g was added to this solution. This was roiled gradually and the solid appeared. This was stirred for 24 hours in the dark place. The filtration was implemented and the filtered one was washed by water and dried. Tetrachloro((S,S,S)-spiro[4.4]nonane-1,6-diamine)platinum(IV) of 0.22 g was obtained. The yield was 43.6%.

| Elementary analysis | C | H | N | Cl | Pt as C₉H₁₈N₂Cl₄Pt |
|---|---|---|---|---|---|
| Calculated value (%) | 22.01 | 3.69 | 5.70 | 28.87 | 39.7 |
| Measured value (%) | 21.54 | 3.58 | 5.36 | 24.88 | 39.2 |

IR(KBr): 3227 (N—H) cm⁻¹

MS(ESI): m/z 490

From the above results, it was identified that this compound had the chemical structure which was represented by a (compound 5).

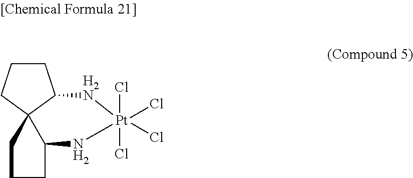

### Embodiment 6

As well as the embodiment 5, tetrachloro((R,R,R)-spiro[4.4]nonane-1,6-diamine)platinum(IV) of 0.27 g was obtained from the potassium hexachloroplatinate(IV) and (R,R,R)-spiro[4,4]nonane-1,6-diamine of 0.16 g. The yield was 55.0%.

From the result of the IR measurement, this compound corresponded to the platinum(IV) complex of the Embodiment 5, and it was identified that this compound was a (compound 6).

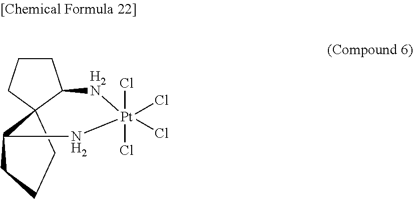

### Embodiment 7

### Medicine Effect Test

The test solution was prepared by dissolving the (compound 1) into the DMSO (dimethylsulfoxide) with the concentration of 8 mg/ml.

The test was implemented by using the human lung cancer cell (LU99), two kind of the human gastric cancer cell (KATO III, MKN-45), the human prostate cancer cell (DU145), the human malignant melanoma cell (G-361), the human bladder cancer cell (T24), two kind of the human lymphoma cell (U937, Jurkat E6.1) and the human leukemia cell (HL60) as the cancer cell.

These cells were suspended in the each culture medium that the serum of 10% was added, and were dispensed in 96-well plate. And then, these were cultured in 5% CO₂ at 37 degrees centigrade during a night. The test solution was prepared in the culture medium to the various concentrations, and was dispensed into the plate that the cells were set preliminarily. And further, these were cultured in 5% CO₂ at 37 degrees centigrade for three days.

The cell proliferation after the medicine addition was measured on the 3rd day from the 1st day after the medicine addition by the MTS method (Kit for cell proliferation test manufactured by Promega Company, Cell Titer 96 Aqueous One Solution Cell Proliferation Assay).

The inhibition rate (%) of the cell proliferation was obtained from the measured MTS value by the following formula.

Inhibition rate(%)=(1−MTS value of medicine addition group/MTS value of medicine non-addition group)×100

Because the value which was obtained by the above-mentioned formula represents the inhibition rate of the cell proliferation, the higher the numerical value is, the higher the medicine effect is. It is deemed that the one whose value is 50% or more has the medicine effect. The result of the kind of the cell which has the high effect is represented below.

TABLE 1
Inhibition rate of cell proliferation after 3 days
from medicine addition (%)

| Concentration of medicinal | | (Compound 1) | | | Oxaliplatin | | |
|---|---|---|---|---|---|---|---|
| solution (μg/ml) | | 5 | 10 | 20 | 5 | 10 | 20 |
| Human gastric cancer cell | KATO III | 53 | 75 | 88 | 58 | 75 | 87 |
| Human lymphoma cell | U937 | 98 | 102 | 101 | 67 | 90 | 99 |
| | Jurkat E6.1 | 92 | 97 | 100 | 90 | 94 | 97 |
| Human leukemia cell | HL60 | 91 | 97 | 99 | 73 | 86 | 93 |

As for the compound 1, it became clear that the medicine effect of the (compound 1) was stronger in the human lymphoma cell and the human leukemia cell as compared with the oxaliplatin which was conventional anticancer agent. Especially, the inhibition rate of the cell proliferation in the low concentration (5 μg/ml) is high, and the compound 1 was effective with a small quantity than the oxaliplatin.

### Embodiment 8

### Medicine Effect Test

The (compound 2) was prepared as the test solution, and the inhibition rate of the cell proliferation was measured by the method similar to the embodiment 7. The result of the kind of the cell which has the high effect is represented below.

TABLE 2
Inhibition rate of cell proliferation after 3 days
from medicine addition (%)

| Concentration of medicinal | | (Compound 2) | | | Oxaliplatin | | |
|---|---|---|---|---|---|---|---|
| solution (μg/ml) | | 5 | 10 | 20 | 5 | 10 | 20 |
| Human gastric cancer cell | KATO III | 78 | 90 | 82 | 58 | 75 | 87 |
| Human prostate cancer cell | DU145 | 51 | 76 | 84 | 46 | 71 | 81 |
| Human bladder cancer cell | T24 | 52 | 77 | 87 | 38 | 43 | 48 |
| Human lymphoma cell | U937 | 100 | 100 | 100 | 67 | 90 | 99 |

As for the compound 2, it became clear that the medicine effect of the (compound 2) was stronger in the human gastric cancer cell, the human bladder cancer cell and the human lymphoma cell as compared with the oxaliplatin which was conventional anticancer agent. Especially, the inhibition rate of the cell proliferation in the low concentration (5 and 10 μg/ml) is high, and the compound 2 was effective with a small quantity than the oxaliplatin.

### Embodiment 9

### Medicine Effect Test

The (compound 5) was prepared as the test solution, and the inhibition rate of the cell proliferation was measured by the method similar to the embodiment 7. The result of the kind of the cell which has the high effect is represented below.

TABLE 3
Inhibition rate of cell proliferation after 3 days
from medicine addition (%)

| Concentration of medicinal | | (Compound 5) | | | Oxaliplatin | | |
|---|---|---|---|---|---|---|---|
| solution (μg/ml) | | 5 | 10 | 20 | 5 | 10 | 20 |
| Human lung cancer cell | LU99 | 65 | 84 | 91 | 38 | 40 | 49 |
| Human gastric cancer cell | MKN-45 | 90 | 93 | 87 | 73 | 82 | 87 |
| Human malignant melanoma | G-361 | 83 | 95 | 98 | 50 | 59 | 74 |
| cell | | | | | | | |
| Human bladder cancer cell | T24 | 79 | 86 | 80 | 38 | 43 | 48 |

As for the compound 5, it became clear that the medicine effect of the (compound 5) was stronger in the human lung cancer cell, the human gastric cancer cell, the human malignant melanoma cell and the human bladder cancer cell as compared with the oxaliplatin which was conventional anticancer agent. Especially, the inhibition rate of the cell proliferation in the low concentration (5 and 10 μg/ml) is high, and the compound 5 was effective with a small quantity than the oxaliplatin.

### Embodiment 10

### Medicine Effect Test

The (compound 6) was prepared as the test solution, and the inhibition rate of the cell proliferation was measured by the method similar to the embodiment 7. The result of the kind of the cell which has the high effect is represented below.

TABLE 4
Inhibition rate of cell proliferation after 3 days
from medicine addition (%)

| Concentration of medicinal | | (Compound 6) | | | Oxaliplatin | | |
|---|---|---|---|---|---|---|---|
| solution (μg/ml) | | 5 | 10 | 20 | 5 | 10 | 20 |
| Human lung cancer cell | LU99 | 89 | 96 | 98 | 38 | 40 | 49 |
| Human gastric cancer cell | MKN-45 | 88 | 80 | 76 | 73 | 82 | 87 |
| Human malignant melanoma | G-361 | 89 | 96 | 98 | 50 | 59 | 74 |
| cell | | | | | | | |
| Human bladder cancer cell | T24 | 78 | 81 | 81 | 38 | 43 | 48 |

As for the compound 6, it became clear that the medicine effect of the (compound 6) was stronger in the human lung cancer cell, the human malignant melanoma cell and the human bladder cancer cell as compared with the oxaliplatin which was conventional anticancer agent. Especially, the inhibition rate of the cell proliferation in the low concentration (5 and 10 μg/ml) is high, and the compound 6 was effective with a small quantity than the oxaliplatin.

From the above results of the embodiment 7-10, the new platinum(IV) complexes of this invention has the strong antitumor activity for various malignant tumors such as human lung cancer cell, human gastric cancer cell, human prostate cancer cell, human malignant melanoma cell, human bladder cancer cell, human lymphoma cell, human leukemia cell, and has the effect compared with the conventional therapeutic agent for the malignant tumor of the platinum complex with smaller doses. Therefore, the side-effect is reduced relatively.

### INDUSTRIAL APPLICABILITY

As described above, the platinum complex of this invention has the strong antitumor activity, and is efficacious as the therapeutic agent for the malignant tumor.

1. Platinum(IV) complexes, comprising:
cis,cis-spiro[4,4]nonane-1,6-diamine (A) ligand represented by a following stereostructual formula.

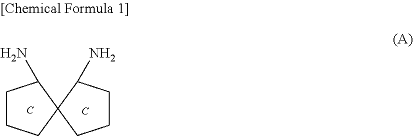

2. The platinum(IV) complexes, according to claim 1, comprising:
Optically active (S,S,S)-spiro[4,4]nonane-1,6-diamine (B) ligand and optically active (R,R,R)-spiro[4,4]nonane-1,6-diamine (C) ligand represented by following stereostructual formulas.

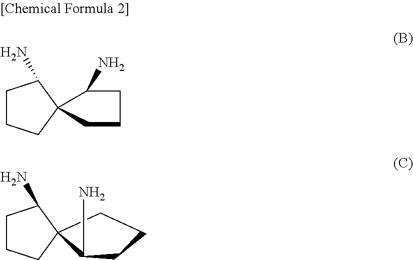

3. The platinum(IV) complexes, according to claim 1, comprising:
cis,cis-spiro[4,4]nonane-1,6-diamine (A) ligand represented by a following general formula (D). 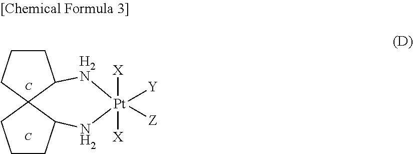
(In the formula, X and Y, Z are same or different, and X and Y, Z represent halogen atoms or monovalent anionic group including acetate group respectively, or Y and Z cooperatively represent the divalent residue which is represented by the formula (b).) 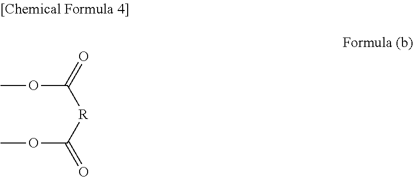
(In the formula, R represents the single bond or represents the straight-chain or branched-chain divalent hydrocarbon residue whose number of carbon atom is 1-6. The hydrocarbon residue may have the unsaturated bond, and the hydrocarbon residue may form the spiro structure.)

4. The platinum(IV) complexes, according to claim 2, comprising:
Optically active (S,S,S)-spiro[4,4]nonane-1,6-diamine (B) ligand and optically active (R,R,R)-spiro[4,4]nonane-1,6-diamine (C) ligand represented by following stereostructual formulas (E) and (F). 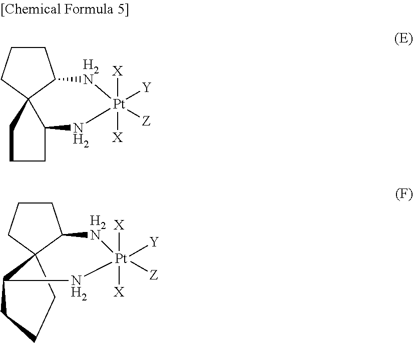
(In the formula, X and Y, Z are same or different, and X and Y, Z represent halogen atoms or monovalent anionic group including acetate group respectively, or Y and Z cooperatively represent the divalent residue which is represented by the formula (b).) 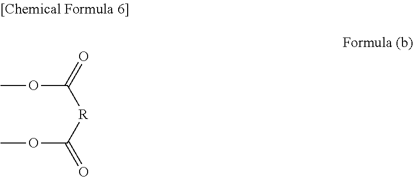
(In the formula, R represents the single bond or represents the straight-chain or branched-chain divalent hydrocarbon residue whose number of carbon atom is 1-6. The hydrocarbon residue may have the unsaturated bond, and the hydrocarbon residue may form the spiro structure.)

5. The platinum(IV) complexes, according to claim 3 and claim 4, wherein:
X are chlorine atoms.

6. Dichloromalonatoplatinum(IV) complexes according to any one of claims of claim 1 to claim 4, comprising:
the ((S,S,S)-spiro[4,4]nonane-1,6-diamine) ligand represented by a following formula (G),
wherein, X are chlorine atoms.

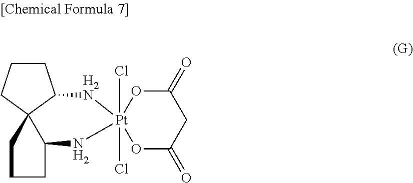

7. A pharmaceutical composition, wherein:
the platinum(IV) complexes described in any one of claims of claim 1 to claim 6 is contained as an active ingredient.

8. A therapeutic agent for a malignant tumor, wherein:
the platinum(IV) complexes described in any one of claims of claim 1 to claim 6 is contained as an active ingredient.
